(19) United States
(12) Patent Application Publication
(10) Pub. No.: US 2002/0026435 A1
(43) Pub. Date: Feb. 28, 2002

(54) Knowledge-base system and method

(76) Inventors: Felix Immanuel Wyss, Bloomington, IN (US); Stephen Andrew Hockema, Bloomington, IN (US); Donald Eugene Brown, Indianapolis, IN (US)

Correspondence Address: Woodard, Emhardt, Naughton, Moriarty and McNett, Bank One Center/Tower, 111 Monument Circle, Suite 3700, Indianapolis, IN, 46204-5137, US

(21) Appl. No.: 09/931,209

(22) Filed: Aug. 16, 2001

Related U.S. Application Data
(60) Provisional application No. 60/228,725, filed on Aug. 26, 2000.

(51) Int. Cl. G06F 7/00

(52) U.S. Cl. 707/1; 704/1

(57) ABSTRACT

A knowledge-base system includes a processor, a database, and a matcher for matching questions of clients to answers in the database. The knowledge-base system can be administered by emails sent to the system. Question-answer entries can be added, deleted, and modified through the use of emails and/or other forms. The system can be accessed over a network or directly accessed with an administration computer. Questions and answers are separately indexed in the system to increase the accuracy of generated results. The generated response sent to the client can be modified based on the question asked, the results, and predefined templates. The system can also detect when the system receives a reply from a customer in response to sent results. Once a reply is detected, the email is forwarded to an alternate email address.

### CROSS-REFERENCE TO RELATED APPLICATIONS

The present application claims the benefit of commonly owned U.S. Provisional Patent Application No. 60/228,725, filed Aug. 26, 2000, which is hereby incorporated by reference in its entirety.

### BACKGROUND OF TEE INVENTION

The present invention relates to knowledge-base systems, and more specifically, but not exclusively, relates to a knowledge-base system configured to uniquely process and respond to inquiries.

Knowledge-base systems or frequently asked questions lists (FAQs) are used in a wide variety of situations such as for customer service and sales. Organizations today are being swamped with questions from customers and even their own employees. Instead of using a telephone, however, more frequently these inquiries are being sent using alternate sources like web sites and emails. This can create a glut of online information requests that have to be processed by human beings. A customer service representative responding to such emails can be easily overwhelmed, and the responses to the requests may not be timely delivered. This can create dissatisfaction on the part of a customer, which in turn can lead to lost sales. In response to this problem, automated systems have been developed to process questions. Although such automated systems provide quicker responses to questions, the results generated by such systems can be typically less accurate than answers from a human being. The client then may repeatedly ask the same question in different ways in an attempt to receive the desired answer from the automated system, and this can lead to frustration. Another problem associated with such automated systems is that they can be hard to maintain. Therefore, there has been a long felt need for an easily maintainable knowledge-base system that can quickly and accurately reply to client inquiries.

### SUMMARY OF THE INVENTION

One form of the present invention is a unique method for automatically processing incoming questions. Other forms of the invention include a unique method of generating a response to a question from a client and a unique knowledge-base system.

A further form of the invention is directed to a unique method of processing incoming messages. A knowledge-base system is configured to store a database containing answers to questions. The knowledge-base system is operatively coupled to a client computer. A message is received from the client computer, and it is determined whether the message from the client computer was a reply to a previously generated message from the knowledge-base system. The message is forwarded from the client computer to a representative in response to this determination.

Still another form of the invention includes operating a knowledge-base system configured to store a database containing answers to questions and a number of response templates each providing a different response format. The system is operatively coupled to a client computer. An input is received from the client computer that corresponds to a question. A query result is generated from the database in response to the question from the client computer. A response message is created based on the question from the client computer, at least one of the response templates, and the query result. The response message is sent to the client computer.

A further form of the present invention includes operating a system configured with a database including a plurality of question-answer sets. A query input to the system is received, and the input includes a word. The system selects one or more of the sets in response to the query input by evaluating the presence of the word in one or more answers of the sets differently than the presence of the word in one or more questions of the sets. The system provides a response output based on the selection. This response can be based on one or more of the sets selected in accordance with the evaluation. The evaluation can include: weighting the one or more answers more than the one or more questions, or weighting the one or more answers less than the one or more questions. Additionally or alternatively, this form can also include generating one or more word indices that are referenced during the evaluation.

Another form of the present invention includes operating a knowledge-base system configured to store a database formatted with a number of question-answer sets. The sets each include a question field and a corresponding answer field. Each of the question and answer fields is configured to contain one or more words. The knowledge-base system is operatively coupled to a client computer. A question index is generated that associates each of the words in the question fields with each of the question-answer sets, and an answer index is generated that associates the words in the answer fields with each of the question-answer sets. An input is received that corresponds to a question from the client computer. A query result is produced using both the question index and the answer index in response to the question from the client computer, and the query result is sent to the client computer. In one form, the question-answer sets are scored with respect to the question, and a threshold limit is determined based on the scoring. The question-answer sets with scores above the threshold limit are selected.

A further form of the present invention is directed to a unique method for answering a question from a client. A knowledge-base system is configured to store a database formatted with a number of question-answer sets. The knowledge-base system is operatively coupled to a client computer. An input corresponding to a question from the client computer is received, and one or more candidate sets from the question-answer set are selected based on the question from the client computer. A reflexive index that includes the question from the client computer and at least the candidate sets is created. Each question from the candidate sets is scored against the reflexive index, and the question from the client computer is scored against the reflexive index to generate a question score. Candidate sets with scores that favorably correlate with the question score are chosen.

Further forms include various systems or devices that implement one or more methods of the present invention. Another form is directed to a unique system. The system includes means for determining a message from a client computer was a reply to a previously generated internal message from a FAQ database and forwarding the message to an ultimate email address in response. The system further includes means for evaluating question components and answer components of the FAQ database independently relative to an input query, and means for providing a response to the FAQ database query in accordance with one or more response templates. The response templates each relate to a different response format. Moreover, in still further forms of the present invention, any one of these means is included without the remaining means.

Yet further forms include a FAQ database method or system that provides for associating a certain word or words of an input query with a given question-answer set of the database; where the word or words are not presented (or hidden) if that set is used in a response to the input query. In still further forms, a certain word or words of the input query are associated with a question-answer set of the database that are ignored or given a different weight than would result in the absence of this association.

In another form, selection of one or more question-answer sets from a FAQ database is performed by separately evaluating question components of the database and answer components of the database relative to an input question.

In yet other forms, methods or systems include a FAQ database that evaluates input queries by using a temporary or intermediate reflexive index.

A further form is directed to a unique system for processing a question from a client computer. The system includes a database formatted with a number of question-answer sets. The sets each include a question field and a corresponding answer field. Each of the question and answer fields is configured to contain one or more words. The database further includes a question index that associates each of the words in the question fields with each of the question-answer sets and an answer index that associates the words in the answer fields with each of the question-answer sets. A matcher is operatively coupled to the database. The matcher produces a query result using both the question index and the answer index in response to the question from the client computer. A processor is operatively coupled to the matcher, and the processor sends the query result to the client computer.

Other forms, embodiments, objects, features, advantages, and aspects of the present invention shall become apparent from the detailed drawings and description contained herein.

### BRIEF DESCRIPTION OF THE DRAWINGS

FIG. 1 is a diagrammatic view of a communication system.

FIG. 2 shows a view of an add entry display screen for the system of FIG. 1.

FIG. 3 shows text of an add entry email for the system of FIG. 1.

FIG. 4 shows an administrative email for administering the system of FIG. 1.

FIG. 5 shows an edit entry display screen for the system of FIG. 1.

FIG. 6 shows a diagrammatic view of a question-answer entry database table for the system of FIG. 1.

FIG. 7 shows an index table for the system of FIG. 1.

FIG. 8 shows an alternate question display screen for the system of FIG. 1.

FIG. 9 shows an alias definition display screen for the system of FIG. 1.

FIG. 10 shows a question entry form screen for the system of FIG. 1.

FIG. 11 shows text of a client email containing a question to be processed in the system of FIG. 1.

FIG. 12 shows text of a response email to the email of FIG. 11.

FIG. 13 shows a results display screen generated in response to the email of FIG. 11.

FIG. 14 shows text of a “no results” email.

FIG. 15 shows a no result display screen for the system of FIG. 1.

FIG. 16 shows a support options display screen for the system of FIG. 1.

FIG. 17 shows text of an email forwarded to a representative in response to a repeated question from a client.

FIG. 18 shows text of an email forwarded to a representative in response to a repeated question from a client.

FIG. 19 shows text of an email forwarded to a representative in response to a repeated question from a client.

FIG. 20 shows a view query display screen for the system of FIG. 1.

FIG. 21 shows text of a representative alert email for the system of FIG. 1.

FIG. 22 shows a reporting screen for the system of FIG. 1.

FIG. 23 shows a graphical report screen for the system of FIG. 1.

FIG. 24 is a flow diagram illustrating one process for generating a response to an inquiry.

FIG. 25 is a flow diagram illustrating one process of determining if an inquiry should be automatically processed.

FIG. 26 is a flow diagram illustrating one process of generating results in response to a question.

FIG. 27 is a flow diagram illustrating one process of generating a formatted response to a question.

FIGS. 28A-C show text of a response template for the system of FIG. 1.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the art that some of the features which are not relevant to the invention may not be shown for the sake of clarity.

In one embodiment of the present invention, customers and/or employees (clients) can submit questions to a knowledge-base system. The system can detect repeated questions from a particular customer so that a human representative can be alerted to handle the question. The system can also separately index questions and answers to improve the accuracy of the automatically generated answers to questions. The output from these results can be customized by using multiple templates, the question asked, and other information.

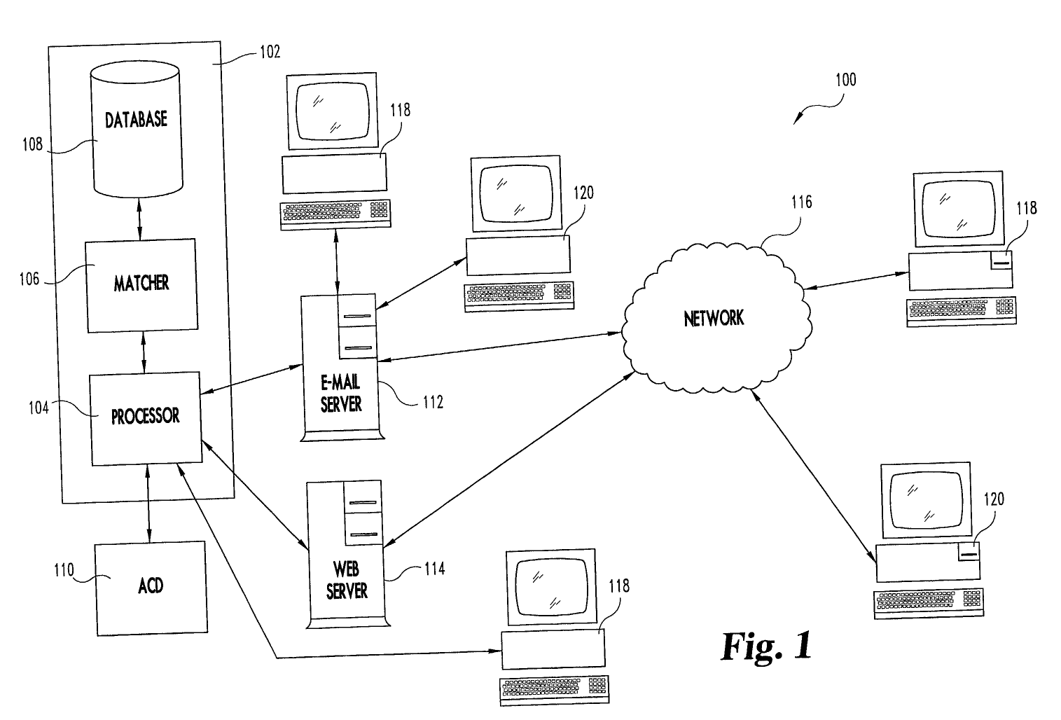

FIG. 1 depicts a communication system 100 of one embodiment of the invention in a diagrammatic form. The communication system 100 includes a knowledge-base system 102 (FAQ system). The system 102 includes a processor 104 for processing information, a matcher 106 for matching input queries or questions with appropriate answers, and a database 108 (answer-base) for storing of information including these answers. Database 108 typically includes a number of entries each including a question/answer set that are hereinafter referred to as Q/A entries. Matcher 106 is responsive to a query or question input to select one or more Q/A entries based on one or more matching techniques as will be more fully described below. The processor 104 may be comprised of one or more components configured as a single unit. For a multi-component form of the processor 104, one or more components can be located remotely relative to the others. One or more components of the processor 104 may be of the electronic variety defining digital circuitry, analog circuitry, or both.

The database 108 can be a standard file, a combination of files, a standard database program, a relational database, a SQL (Structured Query Language) database, and/or other types of data storage structures as generally known by those skilled in the art. In one embodiment, the database 108 is a MICROSOFT SQL SERVER (Microsoft Corporation, Redmond, Wash.). The database 108 is stored in a memory (not shown) associated with processor 104 and/or matcher 106. This memory can include one or more types of solid state electronic memory, magnetic memory, or optical memory, just to name a few. By way of non-limiting example, the memory can include solid state electronic random access memory (RAM), sequential accessible memory (SAM), such as first-in, first-out (FIFO) variety or the last-in, first-out (LIFO) variety, programmable read only memory (PROM), electronically programmable read only memory (EPROM), or electrically erasable programmable read only memory (EEPROM); an optical disc memory (such as a DVD or CDROM); a magnetically encoded hard disc, floppy disc, tape, or cartridge media; or a combination of these memory types. In addition, the memory for the database 108 may be volatile, non-volatile, or a hybrid combination of volatile, non-volatile varieties.

The knowledge-base system 102 can be operatively coupled to an automatic call distribution (ACD) system 110. It is contemplated that the system 102 can also be integrated into the ACD system 110. The ACD system 110 provides communication channels for the knowledge-base system 102 such as voice mail, internet chatting, and other types of communication channels generally known by those skilled in the art. The knowledge-base system 102 can also be located on a single computer or distributed over multiple computers. The system 102 is connected to computer network 116 through email server 112, web server 114, and can be connected in other generally known manners.

Email is routed through the email server 112, and the email server 112 maintains multiple mailboxes for different users and particular departments. The email server 112 can be any type of email server as generally known by those skilled in the art. The web server 114 can be any type of web server as generally known by those skilled in the art. Although one email server 112 is shown, multiple email servers 112 can be operatively connected to the system 102. It is also contemplated that the email server 112 and the web server 114 can be integrated into a single server. Any combination of the system 102, server 112, and server 114 can also be integrated into a single computer, and alternatively the communication system 100 can include only one of the servers 112 or 114. The network 116 includes the Internet and/or one or more other Wide Area Networks (WAN), a Local Area Network (LAN), a proprietary network such as provided by America On Line, Inc., a combination of these, and/or other types of networks generally known to those skilled in the art.

An administration computer 118 is operatively coupled to the knowledge-base system 102 in a number of different manners. As shown, one administration computer 118 is directly coupled to the system 102, and others are shown indirectly connected through network 116 and email server 112. Alternatively, the administration computer 118 can coupled through ACD 110, or other networks, channels, or devices as would occur to those skilled in the art. Administration computers 118 are each configured to administer question/answer entries and various operational features of knowledge-base system 102. Multiple administrators can administer the system 102 at the same time. A client communicates with the knowledge-base system 102 by using a client computer 120. Clients receive answers to their questions by submitting the questions to the knowledge-base system 102 with the client computers 120. The client computer 120 is operatively connected to the knowledge-base system 102 through the network 116, through the email server 112, and/or through the web server 114. It should be understood that while three administration computers 118 and two client computers 120 are shown in FIG. 1, more or fewer of either type can be included in system 100.

Both the administration computer 118 and the client computer 120 have software that allows the computers 118, 120 to communicate with the knowledge-base system 102. This software includes a web browser, an email application, and other types of client software generally known to those skilled in the art. The computers 118, 120 include a personal computer, a computer terminal, a personal digital assistant (PDA), and/or other types of devices generally known to those skilled in the art. In one embodiment, the computers 118, 120 are personal computers with each having a web browser and email client software. Web browsers and email programs are widely available and do not require a customer to load additional software in order to obtain the benefits of the present invention.

The database 108 can store the Q/A entries in a single database table or multiple database tables. An example of a single question-answer database table 600 is shown in FIG. 6; where each line represents a different Q/A entry. For each Q/A entry, table 600 includes an Q/A entry identification number field 602, which is used to identify individual Q/A entries. The table 600 also includes a question field 604 and a corresponding answer field 606 for each Q/A entry. The table 600 can include additional (keyword) fields 608 for storing additional information per Q/A entry. As shown in FIG. 6, additional fields 608 include category fields 610 that in this example relate to different aspects of a business that might utilize system 100, such as sales, production, etc . . . Individual weights given to specific categories in the database 108 are stored in the category fields 610 as a number selected from a predetermined range. These weights are used by the matcher 106 to determine if a Q/A entry should be used in responding to an input query. It is contemplated that the database 108 can include different information and can be structured in a different manner than is shown in FIG. 6. For example, attachments to database entries, such as image files and file address locations, can be stored in the database 108. In addition, the questions and answers can have activation and expiration dates such that they are only available for a specific period of time. This feature for example can be used for questions that relate to a specific holiday period, such as Thanksgiving. As should be appreciated, the question and answers can be stored on separate database tables and associated together with a third table.

The database 108 further includes a word index for locating words in the question-answer table or tables. For example, an index applicable to the single table arrangement of FIG. 6 is depicted as word index table 700 in FIG. 7. The word index table 700 is updated when a new Q/A entry is added to the database 108, a Q/A entry is modified, a Q/A entry is deleted, or when a query is performed. Alternatively or additionally, the index table is constructed or reconstructed at the discretion of the administrator. It is contemplated that the index table 700 can be updated at other times as known by those skilled in the art. The index 700 contains an index of specific words (and/or phrases) and their locations within the database 108. In the FIG. 7 representation, a different word is indexed in each line, and each line of index 700 includes word field 702, Q/A entry identification field 704, question statistic field 706, and answer statistic field 708. Other informative fields, such as keywords, parts of speech and feedback to questions, can also be included in the index table 700.

For each line, the individual indexed (cataloged) words appearing in Q/A entries are stored in the word field 702. The Q/A entry identification number 404 for the Q/A entry in which the word appears is stored in an Q/A entry identification field 704. For example, as shown in FIG. 7, the word “system” is present in Q/A entry number “100” and Q/A entry number “204.” It should be understood that the word in word field 702 can appear in the question part or answer part of a corresponding Q/A entry. For each Q/A entry in which the indexed word of field 702 appears, there is a question statistic field 706 and an answer statistic field 708. Fields 706 and 708 can each contain a grade or statistic pertaining to the indexed word relative to its appearance in the respective question or answer part of the corresponding Q/A entry. These separate statistic fields 706, 708 allow the question and answer fields to be individually graded and indexed. Typically the grade or statistic is a number that is zero when the word does not appear in the corresponding question or answer part and is otherwise greater than zero. A grade can represent the number of occurrences of the indexed word in the question or answer field of the corresponding Q/A entry, the designated weight or importance of an indexed word for the particular Q/A entry to be given during matching, and other types of grading (statistical) information known by those skilled in the art. In another embodiment, two separate database tables are used to provide an index of words appearing in the question part and answer part of the Q/A entries, respectively.

Examples of different types of interfaces for the knowledge-base system 102 will now be described below. The present invention is not intended to be limited to the interfaces described below and shown in the drawings. Other types of interfaces generally known by those skilled in the art are also contemplated to be incorporated alternatively or additionally into the present invention.

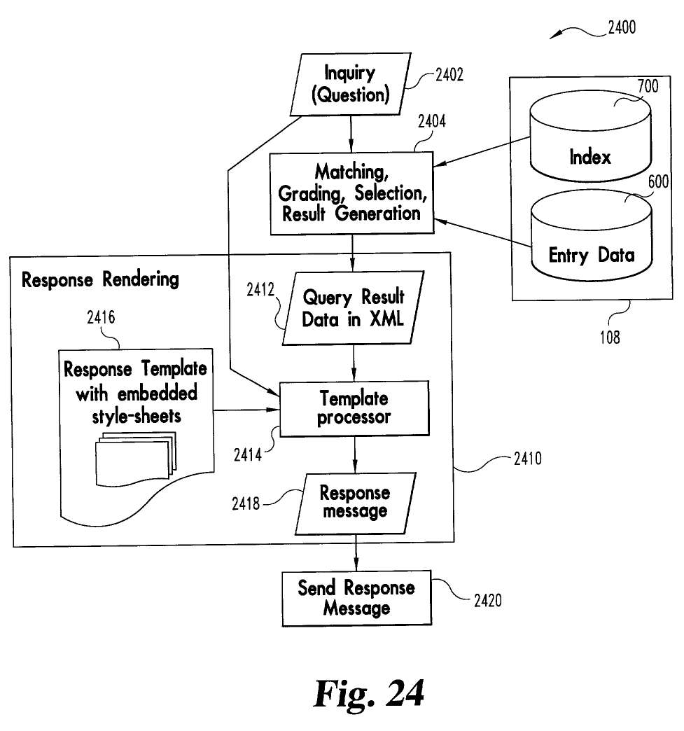

A flow chart 2400 shown in FIG. 24 illustrates how a question is processed in accordance with one embodiment of the invention. Processing begins with stage 2402. In stage 2402, the processor 104 receives an inquiry or question from the client computer 120. The client can ask the question using natural language (e.g., “What time is it?”) or Boolean queries (e.g., “Time” AND “Now”), or using other techniques. The process according to flow chart 2400 is executed for each question or query inputs to system 102.

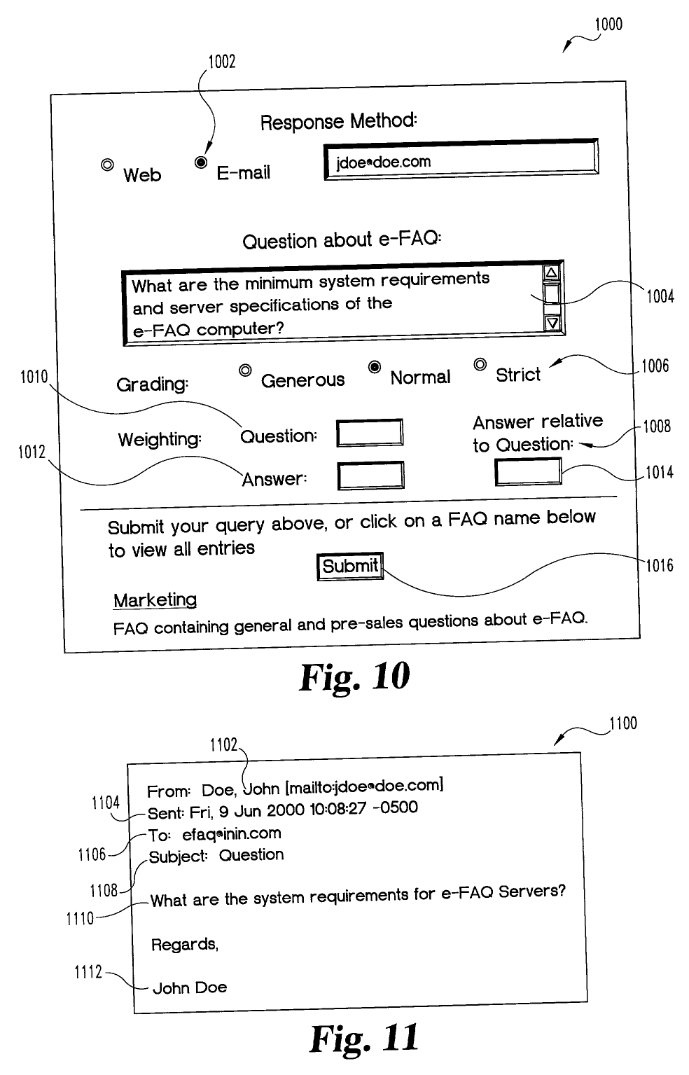

A client can use the client computer 120 to submit queries to system 102 in a number of manners such as through email or by submitting a web-based form. One web-based form embodiment of such an interface is shown in FIG. 10 in the form of question screen 1000. The question screen 1000 includes a response type field 1002 for selecting how the response is sent in the form of a “radio button.” If a client selects the email option in the response type field 1002 (as shown), the client enters the destination email address, and the response is sent to the address via email. If the web option is selected (not shown), then the answer to the question will appear on a web page. It is contemplated that the response method field 1002 includes a faxing option, a telephone option, a paging option, and other communication options known by those skilled in the art.

For the FIG. 10 embodiment, the client enters the question into question field 1004, and selects the degree of grading used for the query in the grading field 1006. These degrees of grading are shown in the radio button form (1) generous, (2) normal, and (3) strict. These degrees correspond to increasingly higher standards that are to be applied by the matching process in selecting which Q/A entries to include in a response to the input query. At the highest extreme, the “strict” grading rule is selected, so that only closely matching results to the question will be returned, and at the lowest extreme the “generous” grading rule is selected, providing a potentially greater number of returns relative to the other degree of grading. In between strict and generous is the “normal” grading degree which is depicted as the selection in FIG. 10. The grading field 1006 can include other types of grading/scoring representations such as a number range where increasing numbers correspond to increased degree (strictness) of matching, a graphical slide control, or as would occur to those skilled in the art.

Question screen 1000 further includes question-answer fields weighting inputs 1008. As discussed above, in different words in the question and answer fields of the Q/A entries are separately graded and/or indexed to improve the accuracy of the results. For inputs 1008, the client has the option of selecting weights to apply to the entire question field and/or answer field of Q/A entries considered in responses to the client question input. Inputs 1000 include question weight field 1010 and answer weight field 1012, respectively, to enter these different weighting factors. An additional relative weight field 1014 is included in inputs 1008 to define a proportional relationship between the question and answers during querying. The question screen 1000 also includes a submit button 1016 to submit the question and/or other relational data, such as attributes or properties that can be used in the search, to the knowledge-base system 1002.

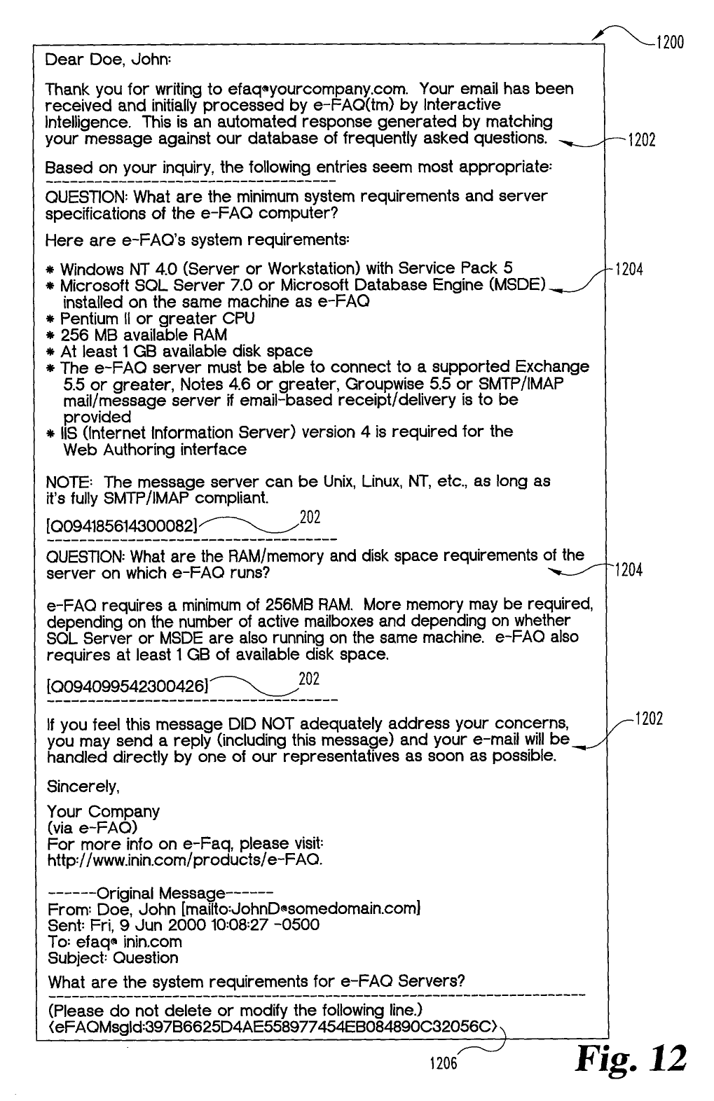

In still yet another embodiment, a client submits the question for stage 2402 of FIG. 24 by sending an email to the knowledge-base system 102. One form for such a question email 1100 is shown in FIG. 11. A question email 1100 includes a “FROM” line 1102, a “SENT” line 1104, a “TO” line 1106, and a “SUBJECT” line 1008. The question 1110 is extracted from the body, the “SUBJECT” line 1008, and/or any other content related field of the question email 1100. The system 102 determines the name of the person sending the email through the “FROM” line 1102 or through a closing 1112. The “TO” line 1106 is addressed to a mailbox, which is monitored by the system 102. The knowledge-base system 102 can process emails from multiple mailboxes for different departments. It is contemplated that the email 1100 can include additional tags or commands that further instruct the knowledge-base system 102. In one embodiment, the email 1100 includes a command to specify the relative weight of the question fields to the answer fields, as described in connection with inputs 1008 for use by matcher 106.

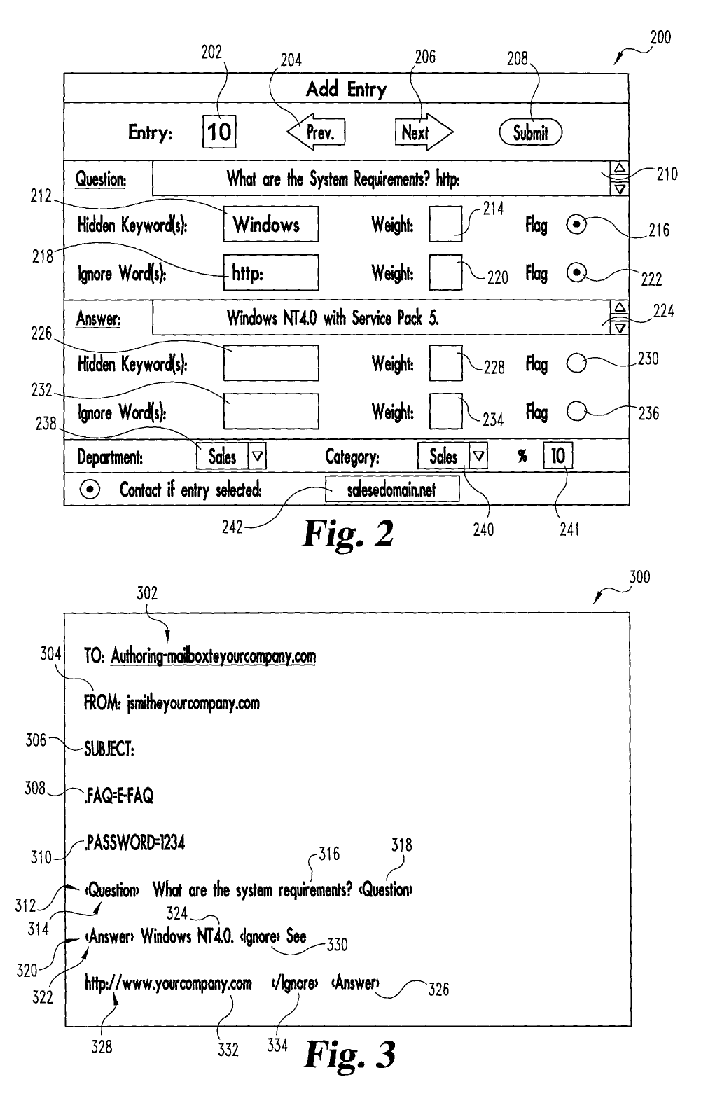

For the process of flow chart 2400 shown in FIG. 24, Q/A entries are stored in the question-answer table 600 and indexed by word index table 700 of the database 108, as respectively described in connection with FIGS. 6 and 7. Each Q/A entry is identified in the database 108 with a unique Q/A entry identification number. An administrator, such as a sales manager, adds Q/A entries into the database 108 by using an add entry screen 200, which is shown in FIG. 2. The add entry screen 200 includes an Q/A entry identification number field 202 that displays the Q/A entry identification number. The screen 200 further includes a previous entry button 204, a next entry button 206, a submit button 208 and other types of control buttons as generally known to those skilled in the art. An administrator types the question into a question field 210.

An administrator can “hide” words in Q/A entries so that the “hidden” words will not be visible to a client when the client receives a response to a question input; however these hidden words will be visible to the administrator and the system 102, and are indexed in the word index table 700. The hidden keywords for questions are entered in hidden keyword field 212 or are designated by using metatags in the question field 210. These hidden keywords are given specific weights by entering the desired weights into weight field 214 or by using metatags. By weighting the hidden keyword(s) in this manner, the corresponding Q/A entry can be afforded special/different treatment by matcher 106 when an input question includes the hidden word. Alternatively or additionally, a hidden keyword can be used to direct different processing of the respective Q/A when a discrete flag is set with keyword flag button 216 or by using metatags. For example, a hidden keyword can be tagged to always cause the associated Q/A entry to be included in a response to an input question containing the hidden keyword. Hidden keywords and/or associated weighting and/or tagging can be used in a wide variety of situations and can improve the accuracy of the results.

Via screen 200, an administrator is provided another option to refine responses. This option permits the selective identification of words with respect to the associated Q/A entry and/or cause the “ignored word” to receive a reduced grade than would otherwise be provided by index table 700. The system 102 also includes a “kill-words” list that contains words such as “a” and “the.” In contrast to entered “ignore words,” words on the kill-words list may or may not be indexed, and if indexed, the kill-words typically have a low weight, usually zero. In one embodiment, the kill-words are indexed and have a weight of zero. Also, the ignore word field 218 is used in querying and only applies to the associated Q/A entries. The weight to reduce the query grade of an individual Q/A entry for these words is entered into a corresponding weight field 220, and a special input field 220 can be used to cause the word to be completely ignored. The ignored word can also be flagged by selecting a flag field 222 so that the Q/A entry will not appear in the results for a question that contains the ignored words. The above functions can also be accomplished by inserting metatags into the question field 210. This ignore word function is especially useful to ignore extraneous words such as web addresses and code that can skew query results.

A corresponding answer to the question is entered into an answer field 224. The answer field 224 also has a hidden keyword field 226, a hidden keyword weight field 228, and a hidden keyword flag 230, which operate the same as the hidden fields 212, 214 and 216 described above, but apply to words in the answer field of associated Q/A entry instead of the question field. In addition, the answer field 224 includes an ignore word field 232 with a corresponding weight field 234 and flag button 236, which operate the same as the ignore fields 218, 220 and 222 described above. These functions can also be accomplished by using metatags or other methods as generally known by those skilled in the art. Further, it is contemplated that the hidden fields 212, 214 & 216, the kill-words list, and ignore fields 218, 220 & 222 can be combined into one set of fields kept jointly for both the questions and answers.

On occasion, input questions can be directed to a given department within a company utilizing system 102 or otherwise processed to determine an applicable department. Add entry screen 200 further includes a department field 238, which is used to associate a department with a Q/A entry. A database table for a Q/A entry may contain a department field to identify for which department a question can be used. In another embodiment, the Q/A entries for different departments can be maintained in separate database tables, separate database instances or in separate databases. The department field 238 is used to further improve the accuracy of the results. The answers to similar questions for different departments may vary. For example, an answer to a sales question may contain price terms; while an answer to a similar technical support question may contain technical information. Certain questions may be universally applicable so that such Q/A entries could have a universal department.

Screen 200 also includes a category (or “attribute”) field 240 having a weight field 241. Fields 240 and 241 can be used to categorize Q/A entries. A Q/A entry can belong to a single category or multiple categories. The weight field 241 specifies the strength of the relationship of a Q/A entry to a specific category. These categories are used to improve the accuracy of the results of a query. By way of example, Q/A entries can be categorized by product line so that questions directed to a specific product line would result in answers specifically related to a certain product line.

The add entry form 200 also includes a contact field 242. The contact field 242 is be used to alert a single person or multiple persons that the specific Q/A entry was included in the results to a question. Email addresses, telephone numbers, pager numbers, and other types of communication identifiers as generally known by those skilled in the art are entered into the contact field 242 to contact one or more corresponding persons.

Instead of using the add entry screen 200, the administrator can administer the knowledge-base system 102 by sending an email. A sample authoring/add entry email 300 is shown in FIG. 3. The authoring email 300 contains typical email header fields such as a “TO” line 302, a “FROM” line 304, and a “SUBJECT” line 306. The “TO” line 302 is addressed to an administration mailbox for the knowledge-base system 102. For example, one such address could be “authoring-mailboxt@yourcompany.com”. The system 102 can have different administration mailboxes for different departments and/or different administration authorization levels. Alternatively, a single mailbox can be used, and the contents of the authoring email 300 can be used to discriminate among departments and/or administrators. The “FROM” line 304 is used by the knowledge-base system 102 to identify the administrator. The “SUBJECT” line 306 can contain a question or other type of information. A FAQ command 308 is used to identify the database or table (department) that is to be modified. The password of the administrator is entered with the password command 310. A question 312 includes a begin question tag 314, question text 316, and end of question tag 318. The corresponding answer 320 to the question 312 is indicated by a begin answer tag 322, answer text 324 and end answer tag 326. The question command 312 is optional, because by default the “SUBJECT” line 306 is considered the question. The hidden and ignore word commands can also be carried out by using metatags. As shown in FIG. 3, the answer 320 includes an ignore word section 328. This ignore section 328 includes a begin ignore text tag 330, ignored text 332, and end of ignore tag 334. The email includes other commands and can include multiple Q/A entries. It is contemplated that other types of commands and syntax can be used to enter data as generally known by those skilled in the art.

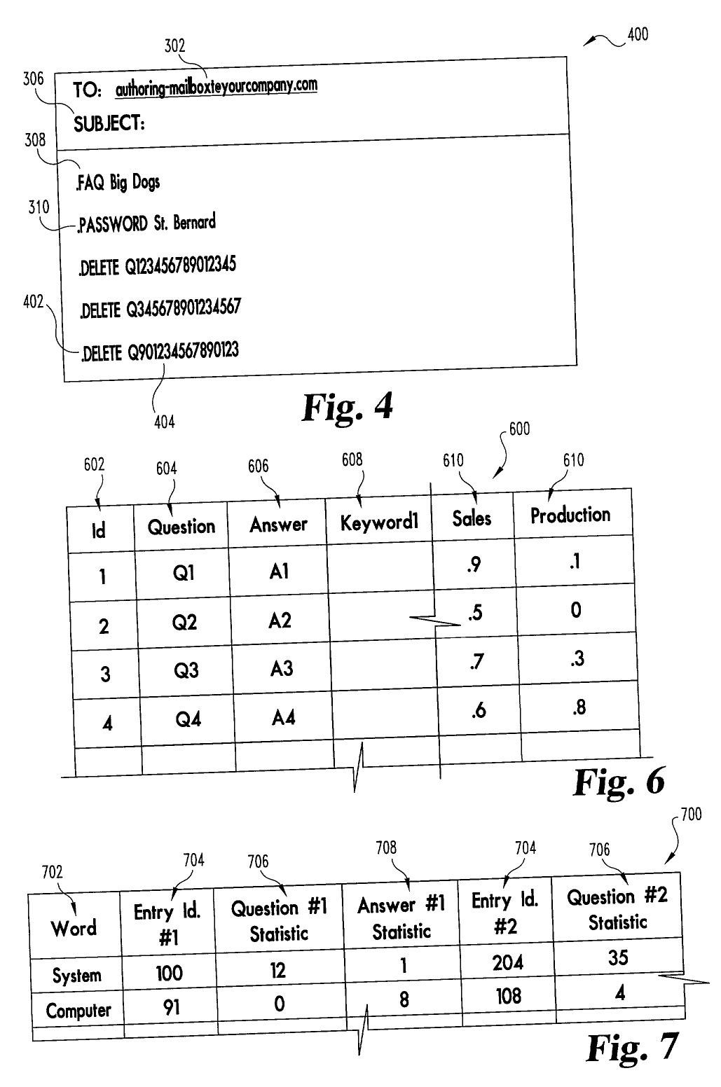

Another type of administrative email 400 is shown in FIG. 4. In this email 400, specific Q/A entries in the database 108 are being deleted by using a delete command 402 along with the Q/A entry identification numbers 404 of the Q/A entry to be deleted.

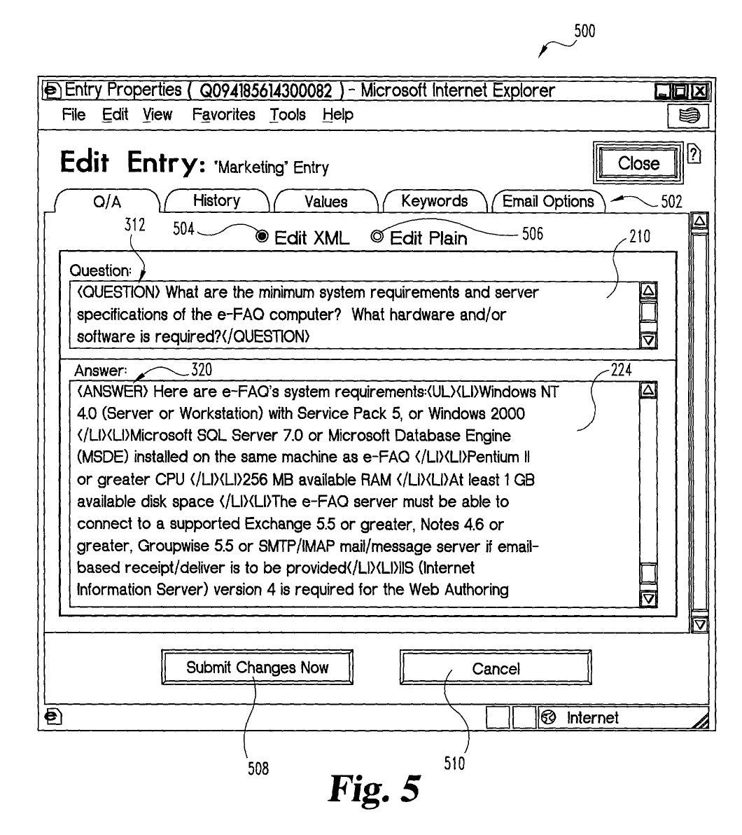

After a Q/A entry is entered into the database 108, the Q/A entry can be edited using an email similar to the ones shown in FIGS. 3 and 4, or the Q/A entry can be edited by using an edit entry screen 500 as shown in FIG. 5. The edit entry screen 500 includes options tabs 502 that are used to organize the different input fields. The edit entry screen 500 further includes an edit mark-up language button 504 and an edit plain text button 506. If the edit mark-up language button 504 is selected, the tags for the question 210 and answer 224 fields are displayed. If the edit plain text 502 button is selected, then only the text of the question 210 and answer 224 are displayed. Once the desired changes to a Q/A entry are made, submit changes button 508 of screen 500 is selected to enter the changes into the database 108. The changes to the Q/A entry can be cancelled with cancel button 510 of screen 500. As should be understood, other types of editors, such as text editors (HTML editors), can be used to create and edit Q/A entries.

Referring to FIG. 24, in stage 2404 the matcher 106 queries the database 108 in order to find Q/A entries relevant to the question. The matcher 106 uses the word index 700 from database 108 and the question-answer table 600 to generate a response. It is contemplated that the matching can occur without using the index 700. In addition, the matcher 106 can retrieve Q/A entries stored in separate tables 600 and/or in separate databases 108.

For one embodiment, the procedure executed by matcher 106 of system 102 includes comparing each word from the question to the words contained in the word index 700. As shown in FIG. 7, the Q/A entry identification numbers 704 of Q/A entries containing matching words are identified. Each matching Q/A entry is scored based upon the values contained in the question statistic field 706, the answer statistic field 708, and the relative weighting designated by the client (or predesignated by the administrator) in the question-answer weighting inputs 1008 of screen 1000 (FIG. 10). For example, the question weight field 1010 can be multiplied by the question statistic 706 to generate a question score for each Q/A entry, and the answer weight field 1012 can be multiplied by the answer statistic field 708 to generate an answer score for each Q/A entry. This calculation can also include the application of factors like category weighting and ignore/hidden word weighting. A score for each Q/A entry is calculated by adding the answer score with the question score for each Q/A entry. It is contemplated that these scores can be calculated in many other manners using many other formulae.

The mean, standard deviation, sample standard deviation and other statistical variables for the population of all Q/A entry score are then calculated. Based on these statistical measurements, grades are calculated for the Q/A entries. The matcher 106 creates and selects the results based upon a desired threshold level for these grades. Both an absolute threshold that applies equally to all questions and a dynamic threshold level that is determined for each question are used to filter the results. Only Q/A entries with scores that satisfy both the absolute and dynamic threshold levels will be included in the results. In one embodiment, the dynamic threshold level is set to a multiple of standard deviation units of all scores greater than the calculated mean of all scores. The results containing all Q/A entries having scores above the threshold levels are selected by the matcher 106. For example, if the dynamic threshold level was two standard deviation units, then only Q/A entries with scores greater than two standard deviation units above the mean score would be selected by the matcher 106. The scores of “good” Q/A entries are not always in the same absolute threshold range for different questions, because the scores vary due to the length of the question, and the number of Q/A entries in the database 108. The dynamic thresholding returns “good” answers and minimizes the occurrence of “false positive” results, which are irrelevant Q/A entries that do not adequately answer the question. Dynamic and absolute thresholds can also be determined/adjusted in response to grading degree inputs provided with the input question by a client.

In another embodiment, the grades can be at least partially based upon the length of the question asked compared to the length of the question for a particular Q/A entry. This is based upon the discovery that people tend to ask questions with the fewest possible words. Accordingly, for this embodiment, Q/A entries whose question fields 604 are closer in length to the query will receive higher matching scores.

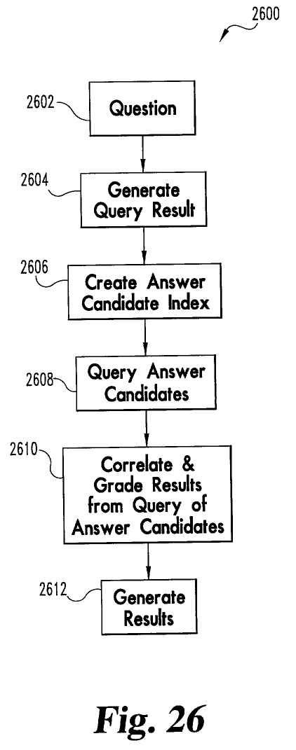

A flow chart 2600 illustrating a querying process according to still yet another embodiment is shown in FIG. 26 that may be indicated in stage 2404 of FIG. 24. This reflexive querying process 2600 helps improve the accuracy of a query. In stage 2602, the knowledge-base system 102 receives a question. The matcher 106 in stage 2604 generates a candidate set of query results. This result set includes the Q/A entries that most closely match the question asked.

In stage 2606, a temporary “reflexive” index (answer candidate index) is created. This temporary index includes the original question and either all of the Q/A entries in the database 108 or only the results generated in stage 2604. In one embodiment, the temporary reflexive index includes the original question and all of the Q/A entries in the database 108. In stage 2608, the temporary index, which now contains the original question, is queried using each of the question fields from the candidate answers from stage 2604, and in stage 2610, the results from this query are correlated and graded with respect to the original question. This correlation can also use dynamic thresholding. In stage 2612, only those candidate entries that, when queried against the temporary reflexive index, hit the original question are included in the response. Thus, this technique helps to reduce the number of “false positive” results returned by eliminating candidate Q/A entries that do not “reflexively” (“symmetrically”) match the question.

Returning to FIG. 24, the individual Q/A entries in the database 108 can be stored in a single database table 700 or multiple database tables. Because under certain circumstances the words in questions may generate more or less accurate results than those contained in the answers, it is desirable to grade question words differently than answer words in some embodiments. In other circumstances where the words in answers may generate more or less accurate results than those contained in the questions, it would desirable to grade question words differently than answer words. By having separate grading for the question and answers in table 700, the question and answer fields can be independently graded based on index table 700 inputs and/or client weighting inputs 1008 of screen 1000.

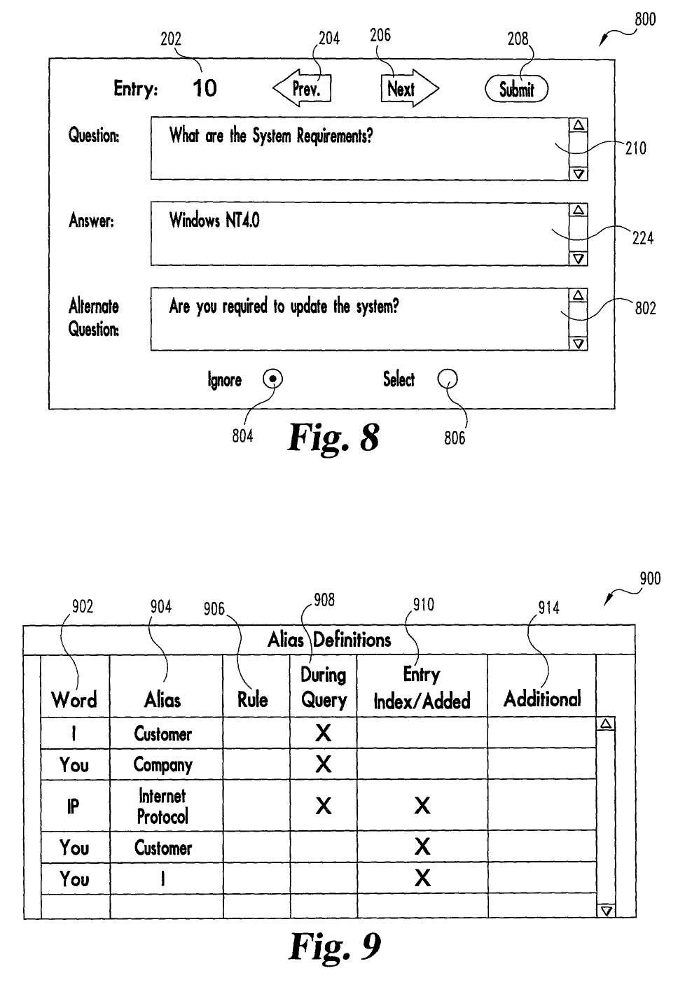

It should be appreciated that a given poorly worded question may generate a response that is less accurate than might be obtained with different wording. One way to address this situation is to designate specific words in the ignore and hidden keyword fields 212, 218. Another solution will be described in reference to FIG. 8. The knowledge-base system 102 includes an alternate entry control screen 800. The alternate entry control screen 800 includes an alternate question 802 for a specific Q/A entry. An administrator selects either an ignore button 804 or a select button 806. The ignore button 804 tells the system 102 that the results should not contain the specific Q/A entry if the alternate question 802 is asked. If the select button 806 is selected, then the Q/A entry will be treated as if the Q/A entry contained the alternate question 802. Thus, a question containing a form of one of the alternate questions 802 would hit the corresponding Q/A entry. In another embodiment, a weight field for the alternate question 802 is added to the screen 800 for consideration in the operation of matcher 106 in order to reduce or increase the confidence in the match proportionally.

Another common problem that exists with FAQ databases is the inability of the FAQ system to define certain words within context. When a customer asks a question that contains the word “I”, a typical system does not know that “I” refers to the customer. This is equally applicable to abbreviations of words. To remedy this problem, the knowledge-base system 102 includes an alias definition screen 900. The alias definition screen 900 allows an administrator to define the meaning of words in specific context, and allows the system 102 to utilize the word/abbreviation only in certain situations. The alias definition screen 900 includes a word field 902, and an alias field 904 that contains an alternate word for the word contained in the word field 902. The alias definition screen 900 includes a rule field 906 in which context specific rules are defined. A substitute during query field 908 is selected when the word substitution should take place during a query, and a substitute during index field 910 indicates that the word substitution should occur when a Q/A entry is indexed. The alias screen 900 further includes an additional substitution fields 914 as would occur to those skilled in the art. For example, “IP” and “Internet Protocol” as shown in FIG. 9 can be alternatively substituted when the matcher 106 queries the database 108. In another embodiment, the database 108 includes a predefined library of synonyms for words. The database 108 can incorporate the synonym library and the alias list into the word index 700 or can separately index the synonym library and the alias list.

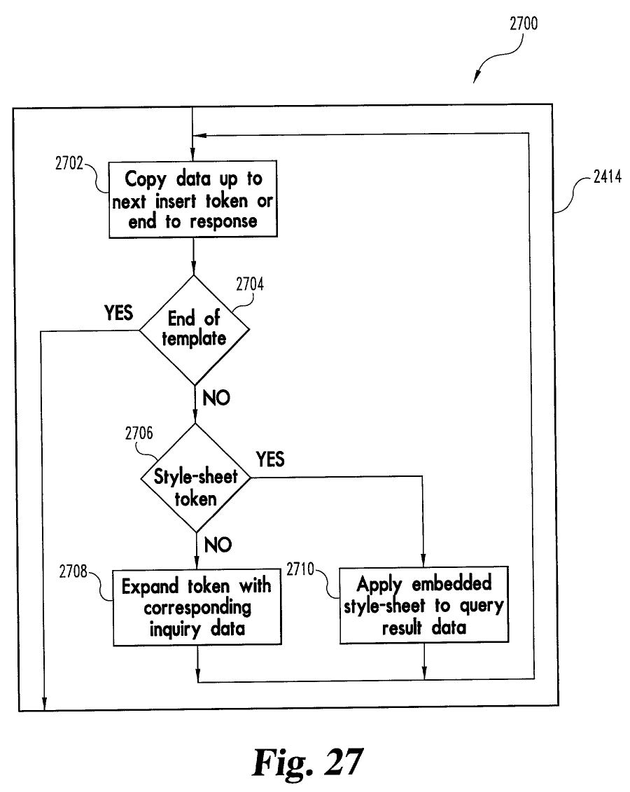

Referring back to FIG. 24, the response to the question is created in the response rendering portion 2410. The query results in stage 2412 are sent to the processor 104 in an extensible mark up language (XML) file. The results can also be sent as a stream of data, a plain text file, and in other forms as would be contemplated by those skilled in the art. The processor 104 processes and formats the output. In one embodiment, the results and original question are applied to a corresponding template with embedded style sheets 2416. As more fully described in connection with FIG. 27, the multiple embedded style sheets 2416 give the system 102 the ability to customize a response based on the context of the question and the generated answer.

A flow chart 2700 showing a detailed view of the template processing subroutine 2414 is shown in FIG. 27. The template processing method can be used in conjunction with HTML (hypertext mark-up language), XML and/or in other manners as generally known by those skilled in the art.

The template processing stage 2414 uses the original question, the query results, and at least one of a multiple templates with embedded style sheets. The processor 104 in stage 2702 copies the data from the style sheet until an insert token or an end of template token (end to response tag) is copied. If the end of template token is found in stage 2704, then the formatting of the response message is complete, and the formatted message is sent to be processed in stage 2418. In stage 2706, the processor 104 determines whether a style-sheet token has been found. If the processor does not find a style-sheet token, then in stage 2708 the processor inserts and formats at least a portion of the original question sent by the client into the response message. When a style-sheet token is found, then the results from the query are formatted and inserted into the response message according to the style-sheets in stage 2710. The response message is processed in the template processing stage 2414 until the end of response token is found.

The multiple embedded style sheets 2416 are HTML or XML files that contain tags (or commands) which instruct the system 102 on how to format a response. It is contemplated that the sheets 2416 can includes other formatting file types as known by those skilled in the art. The tags in the sheets 2416 can refer to specific query result fields from stage 2412 or fields contained in the question from stage 2402. The response is also formatted based on any conditions contained within the tags in the sheets 2416. For example, the formatted response can be based on a variety of characteristics including to which department the original question relates. A response to a question directed to a sales department can be completely different from a response to the same question directed to a different department (such as engineering). A response message is generated in stage 2418, and in stage 2420 the message is sent to the client in the manner specified in the response method field 1002 shown in FIG. 10.

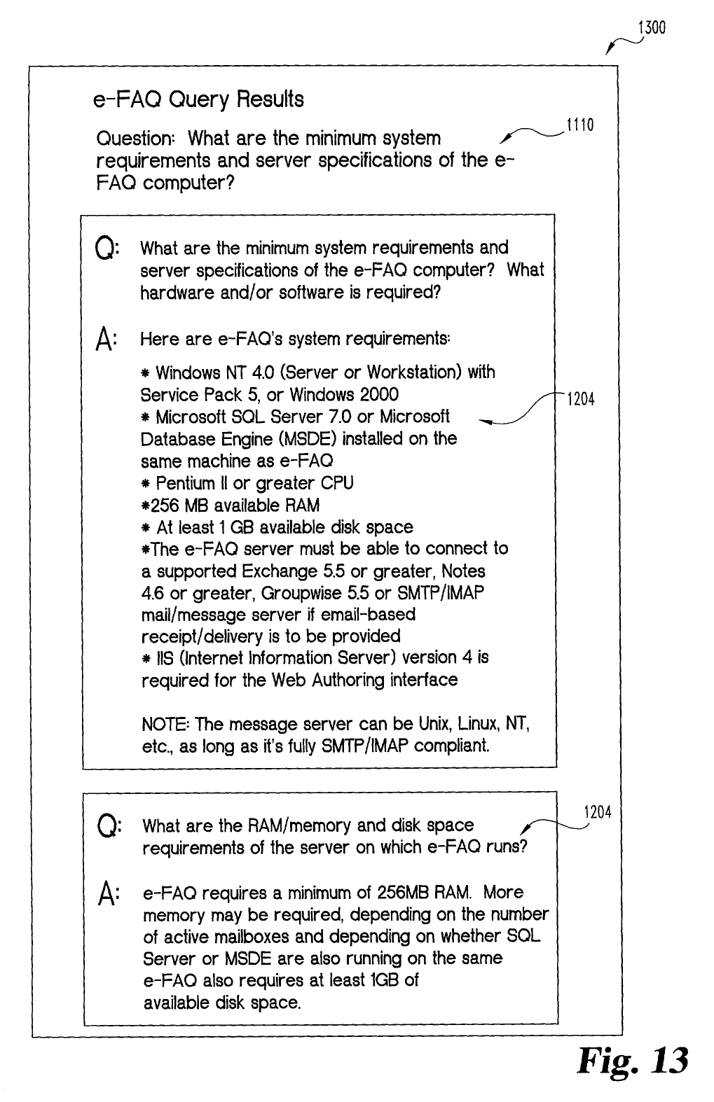

The multiple response templates in stage 2416 allow the system 102 to generate a wide variety of responses, including alerts and reports. A number of these different types responses than can be generated in the response rendering procedure 2410 will now be described with reference to FIGS. 12-21. It is contemplated that other types of responses in addition to those shown can be generated in the response rendering procedure 2410.

One type of response is a response email 1200 that is shown in FIG. 12. The response email contains additional information, which can be used by the client, and at least one question-answer result field 1204. Each question-answer result field 1204 contains the corresponding Q/A entry identification number 202. A message identification number 1206 is included in response email 1200 to identify the particular query submitted, and the message identification number 1206 can also be used to identify replies from the client (which will be discussed in further detail below). The response email 1200 can contain hyperlinks and other types of information as would be contemplated by those skilled in the art. In addition, the response email 1200 can contain certain attachment files based on the Q/A entries contained in the results, the template, and/or specific Q/A entry attributes. In another embodiment, a response screen 1300 displays information similar to the email 1200 and is viewed through a web browser.

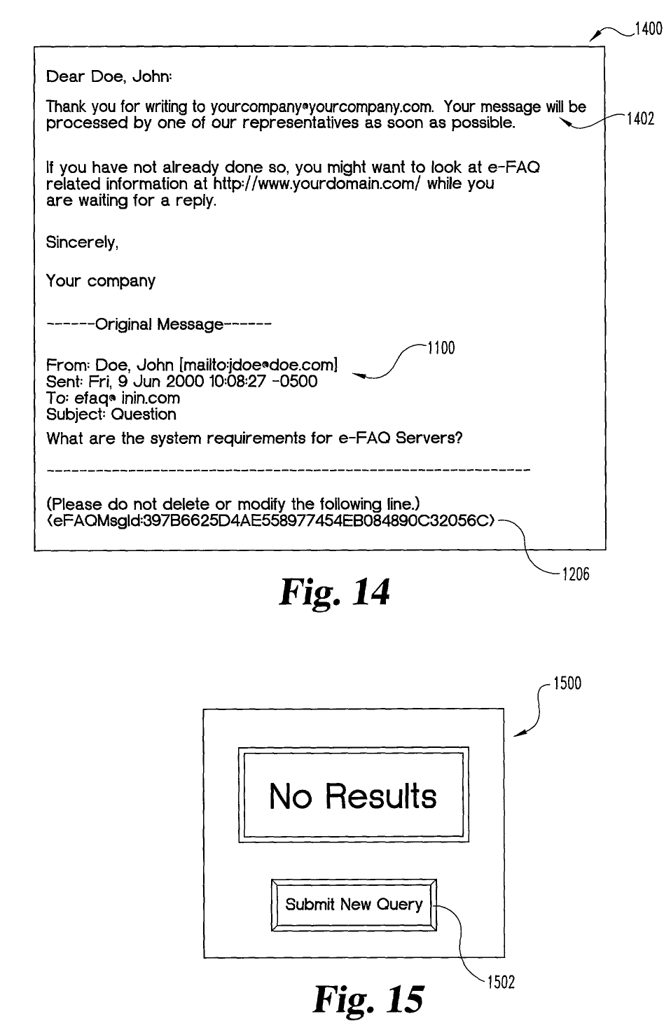

If the matcher 106 fails to return any matching Q/A entries, a “no results” email 1400 or a “no results” screen 1500, respectively, is returned depending on the response method 1002 selected by the client. The “no results” email 1400 and screen 1500 are generated because the system 102 is unable at that time to automatically generate an answer to the question. A copy of the original query and the no results email 1400 can also be sent to an alternate mailbox so as to notify a human agent. As shown in FIG. 14, the no results email further includes a no results message 1402 to provide instructions to a client on how to further proceed. The instructions can include other information such as the name of the person to contact and useful telephone numbers. When a client receives a no results screen 1500 (FIG. 15), the client can submit a new query by selecting the submit new query button 1502.

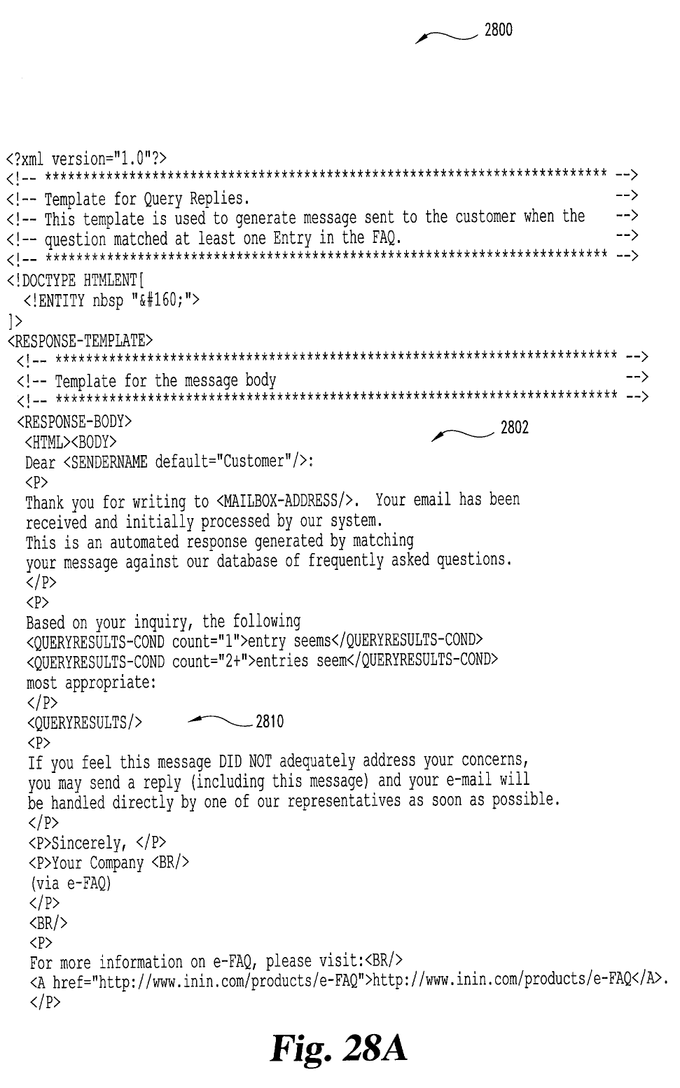

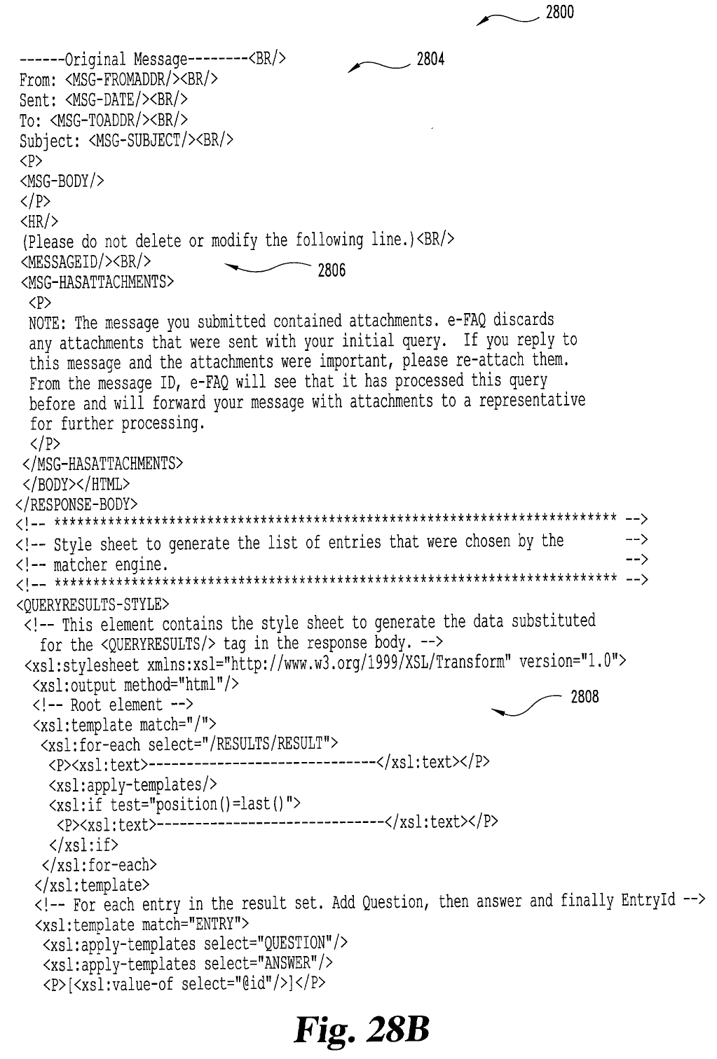

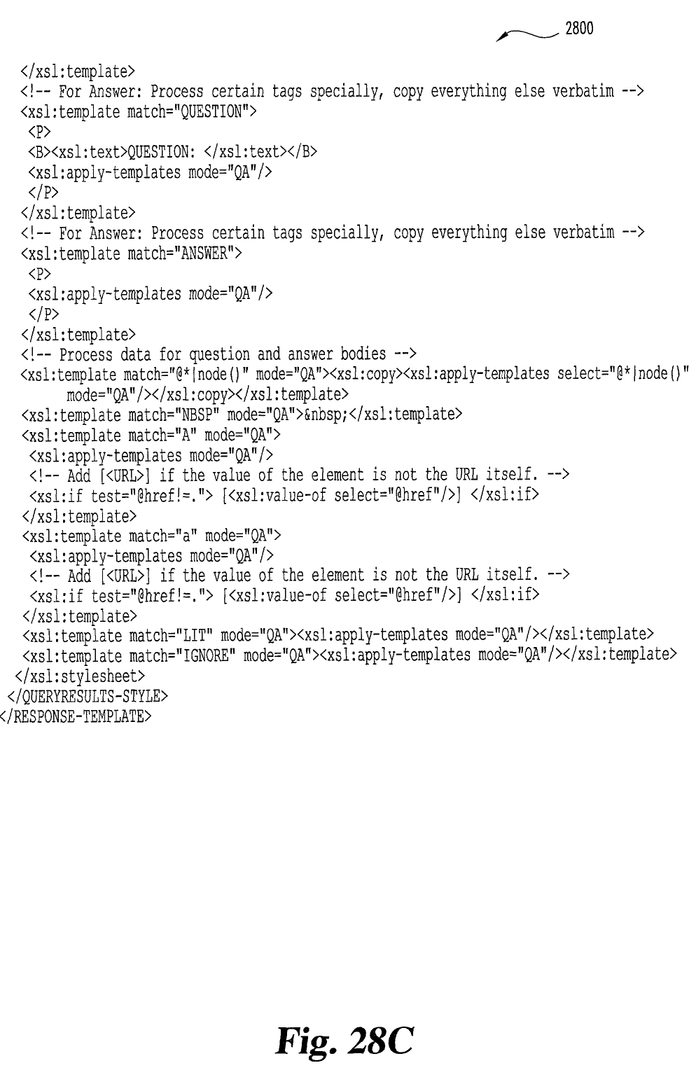

An example of a response template 2800, which is designed to generate the “response” email 1200 of FIG. 12 is shown in FIGS. 28A-C. The response template 2800 includes a message portion 2802 and message information tags 2804 for inserting information from the original message of the client into the response. The template 2800 also includes a message identification tag 2806 for inserting a unique message identification number into the response and a style sheet portion 2808 for formatting the response. In the illustrated embodiment, the use of the embedded style sheet is controlled by query results tag 2810.

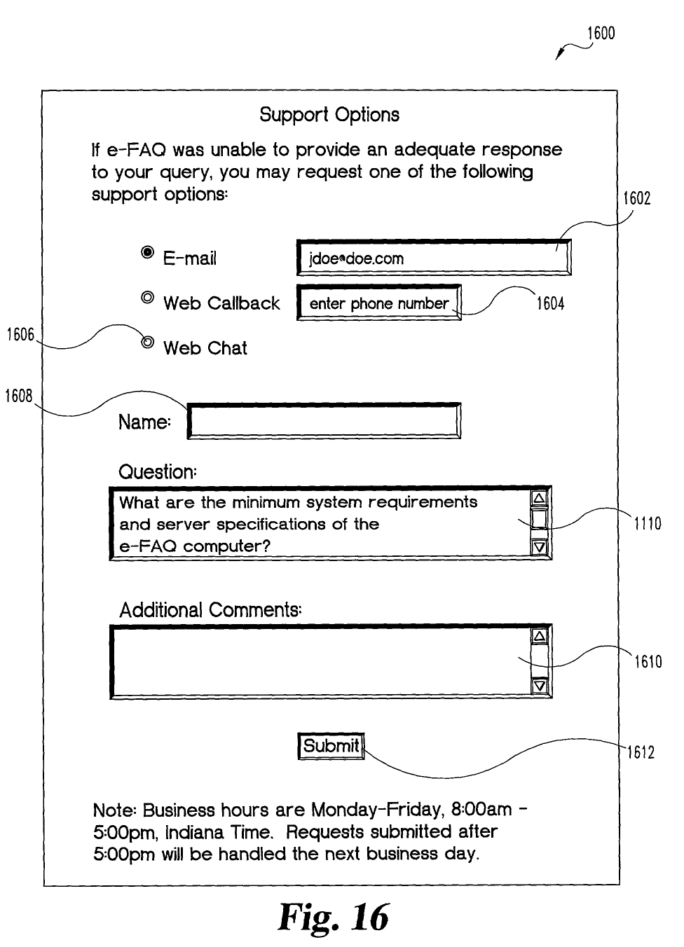

When “no results” are returned for a particular question, a support option screen 1600 can be displayed along with the “no results” screen 1500. The support options screen 1600, as shown in FIG. 16, provides a number of different options through which a client may contact a customer representative. In FIG. 16, these options include an email field 1602, a web callback field 1604, and a web chat field 1606. The name of the client is entered into name field 1608, and the question 1110 is automatically filled into the question field 1110. A client enters additional comments into additional comments field 1610. Submit button 1612 of screen 1600 is used to submit this information to the knowledge-base system 102. The ACD system 110 of FIG. 1 can be used to initiate the web callback and web chat. It is contemplated that the support option screen 1600 can include alternatively or additionally other options as generally known to those skilled in the art, or in fact could be absent in other embodiments.

If a customer replies to the sent email 1200, 1400, the processor 104 of the knowledge-base system 102 is arranged to determine that the message is a reply to a previous response supplied by the system 102. Further, the system 102 also detects when a support options screen 1600 is submitted. When a message is received in stage 2402, as shown in FIG. 24, the system 102 first determines whether the message should be automatically processed or manually answered. If a message is a reply from the customer, then the question is selected to be answered by a human being or sent to a different automated system.

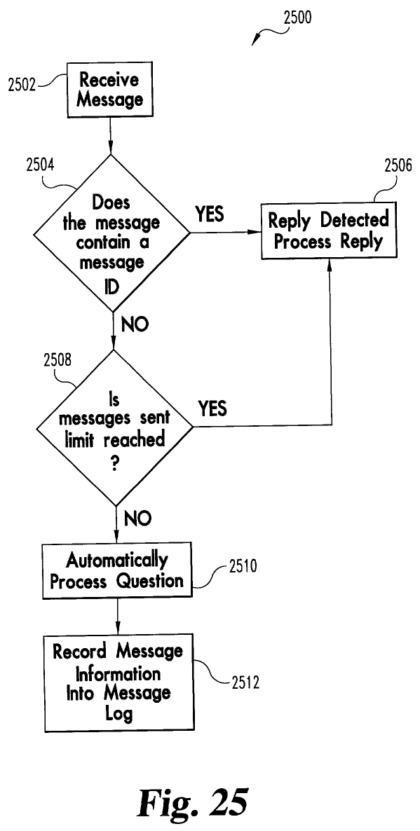

A subroutine for determining whether the message from the client is a reply will now be described with reference to a flow chart 2500 in FIG. 25. The knowledge-base system 102 in stage 2502 receives the message from the client. The system 102 determines if the message contains a message identification number 1206 in stage 2504. If the message contains a message identification number 1206, then the message is forwarded to be processed by a human client representative in stage 2506 or by another automated system.

If no message identification number 1206 is detected, the message may still be a reply, because some email systems delete the original message when a reply is sent. To remedy this problem, the processor 104 maintains in the database 108 a message (communication) log. The message log can contain information such as the email address, the original question in the email, and the date/time the message was sent. One or more parameters or variables can be selected to determine whether a message is a reply. These parameters can include the duration between messages, the number of messages, the question in the message, and other types of criteria as generally known by those skilled in the art. In one embodiment, the interval between messages is the test used. In stage 2510, the processor 104 determines if a specified test has been satisfied. If so, then a reply is detected in stage 2506 and the message is forwarded to the appropriate representative (human or another automated system). If the test is negative, the message is automatically processed by the knowledge-base system 102 in stage 2510, and the response is automatically sent to the requesting client.

In stage 2512, the sent message is recorded in the message log. It is further contemplated that the information from an incoming message can be recorded once the message is received or at different stages during processing. This method 2500 also minimizes the problem of a continuous loop of messages being sent between the system 102 and another automated system. Although this method was be described in reference to an email, this method can be applied in other types of situations. For example, this method could be applied to web-based clients. A web form could contain a hidden metatag with a message identification number.

The system 102 responds to these client replies in stage 2506 by generating a client reply alert message. The client reply alert is automatically sent to one or more customer representatives and/or other automated systems either via email or in some other fashion.

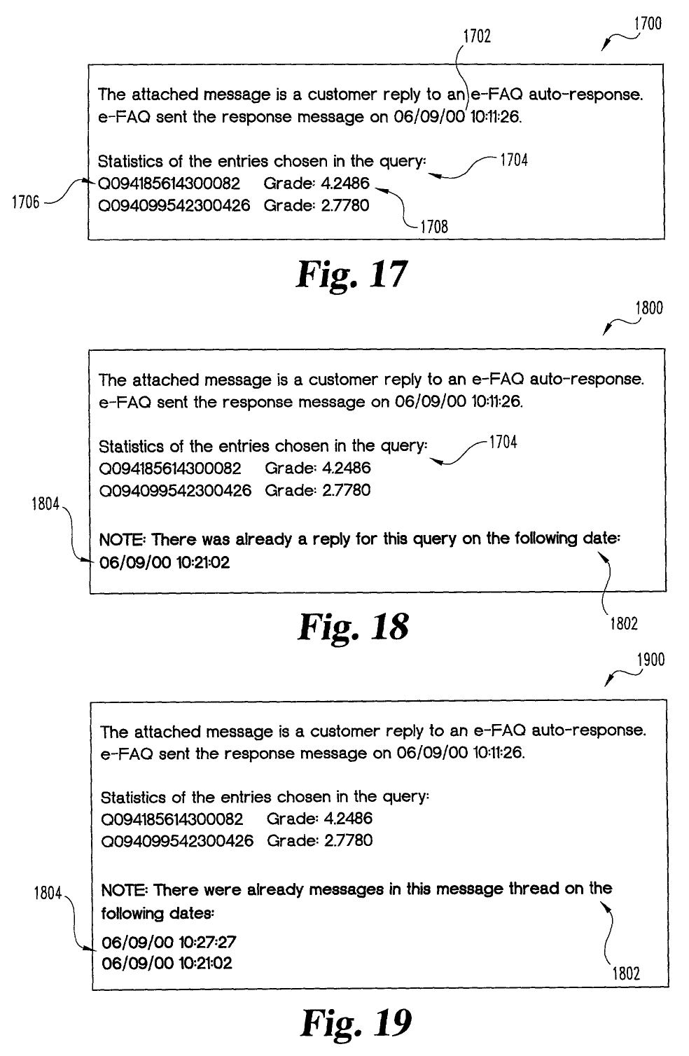

Portions of typical alert emails 1700, 1800 and 1900 are shown in FIGS. 17-19. The alert email 1700 includes, along with previous messages, information such as when the response message was sent in time/date stamp 1702 and query statistics 1704. The query statistics 1704 as shown include the Q/A entry identification number 1706 and the corresponding grade 1708 from the particular query. As should be appreciated, the query statistics 1704 can include additional information. The knowledge-base system 102 along with the ACD system 110 keeps a log of all communications with the customers. If a representative already responded to the email from the client, the knowledge-base system 102 will attach a notification 1802 along with a notification date field 1804 to the customer reply email 1800 (FIG. 18). As shown in FIG. 19, the knowledge-base system 102 also tracks multiple reply dates 1804. This minimizes the risk that a customer will be contacted multiple times about the same problem. It is also contemplated that a customer reply email can include other information such as the message identification number 1206 or hyperlinks to the corresponding data.

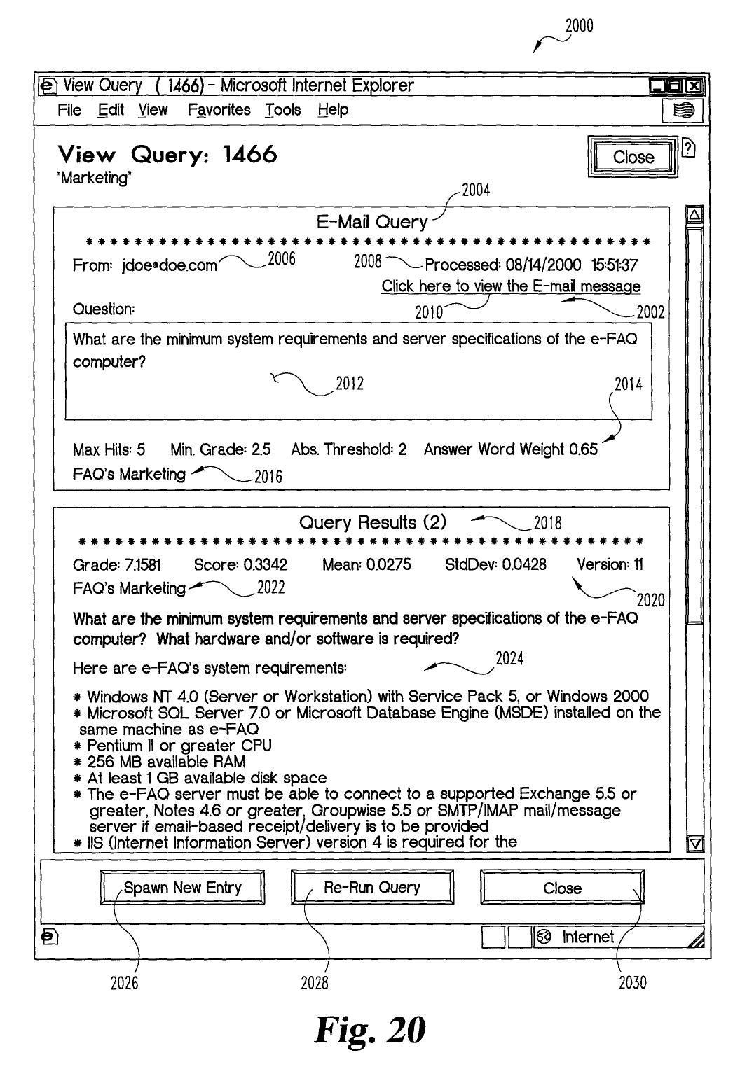

Individual questions asked by customers are tracked by the system 102 and stored in the database 108. A view query screen is used by an administrator to view past queries by a client. A view query screen 2000 according to one embodiment is shown in FIG. 20. The view query screen 2000 includes a query information section 2002 and a query results section 2018. The query information section 2002 includes a response type field 2004 that indicates how the response was sent, a contact address 2006 for the client, a processing date field 2008, a view email button 2010 to view the emails, and a question field 2012. The query information section 2002 further includes a query result statistics area 2014 and a FAQ/Department field 2016. The query results section 2018 displays information about the individual query results. The query results section includes entry result statistics 2020 for individual Q/A entries, a FAQ/Department field 2022, and a resulting question-answer result 2024. The query results section 2018 can also include other types of information as generally known by those skilled in the art. An administrator using the view query screen 2000 can create new Q/A entries by selecting a spawn entry button 2026 of screen 2000. The administrator can add the displayed question-answer pair as a new Q/A entry into database 108 of system 102. In addition, the administrator can rerun the query by selecting the rerun query button 2028. For example, the administrator can test if a change to the parameters of the system had any effect. The view query screen 200 is closed by selecting the close button 2030.

As previously discussed with reference to alternate question entry screen 800 of FIG. 8, an administrator can give “feedback” about Q/A entries by adding additional words to Q/A entries. Furthermore, feedback can also be given about the relative “confidence” in the entries. Based upon review of Q/A entry usage logs, an administrator can increase or decrease the relative likelihood that a Q/A entry will match future questions.

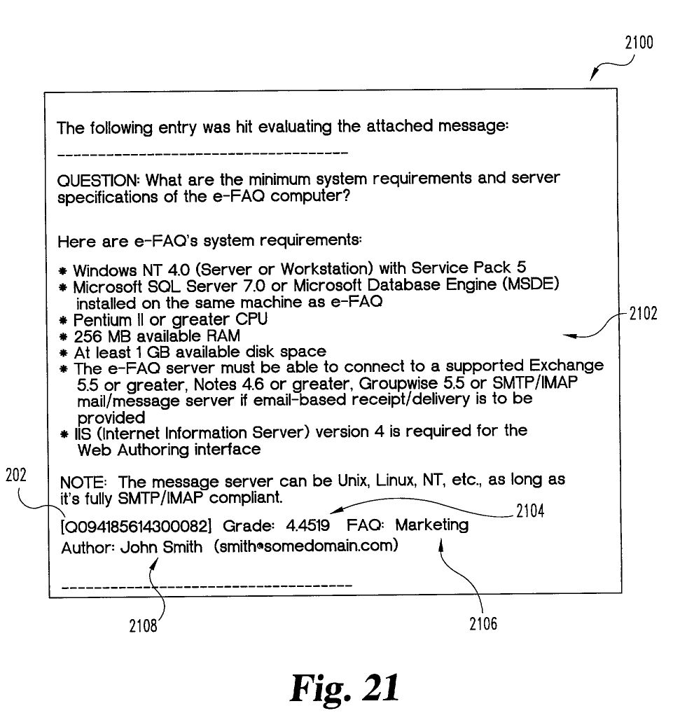

As previously discussed with reference to FIG. 2, the contact field 242 is used to report that a particular Q/A entry has been hit. One such type of reporting email 2100 is shown in FIG. 21. The hit notification email 2100 includes hit Q/A entry information 2102, a Q/A entry identification number 202 for the hit Q/A entry, query statistics 2104, FAQ information 2106, and the author of the question that hit the Q/A entry. It is contemplated that other information can be included in the hit notification email 2100 as would be contemplated by those skilled in the art.

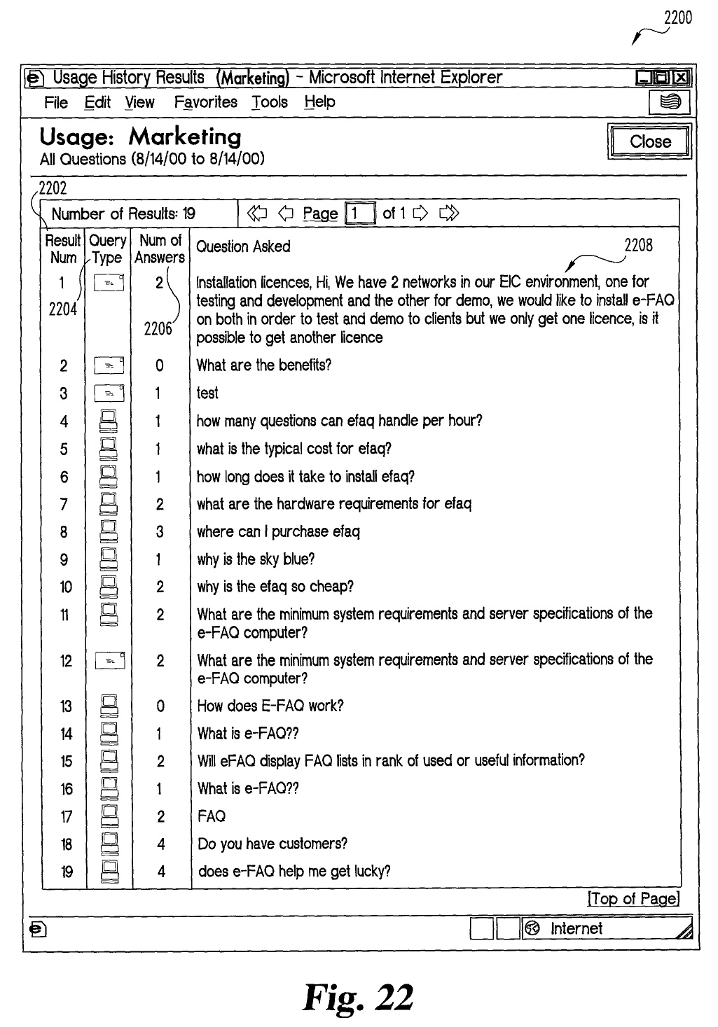

The knowledge-base system 102 further generates reports, which are used to monitor the system 102. An example of one such report is shown in FIG. 22. Reporting screen 2200 includes a result number field 2202 and a query type field 2204 that indicates how the results were sent. A frequency or number of answers field 2206 shows the number of times the Q/A entry was selected and a question asked field 2208 shows the question. This information can be used to develop additional Q/A entries in order to improve responses. This information can also be shown in graphical form.

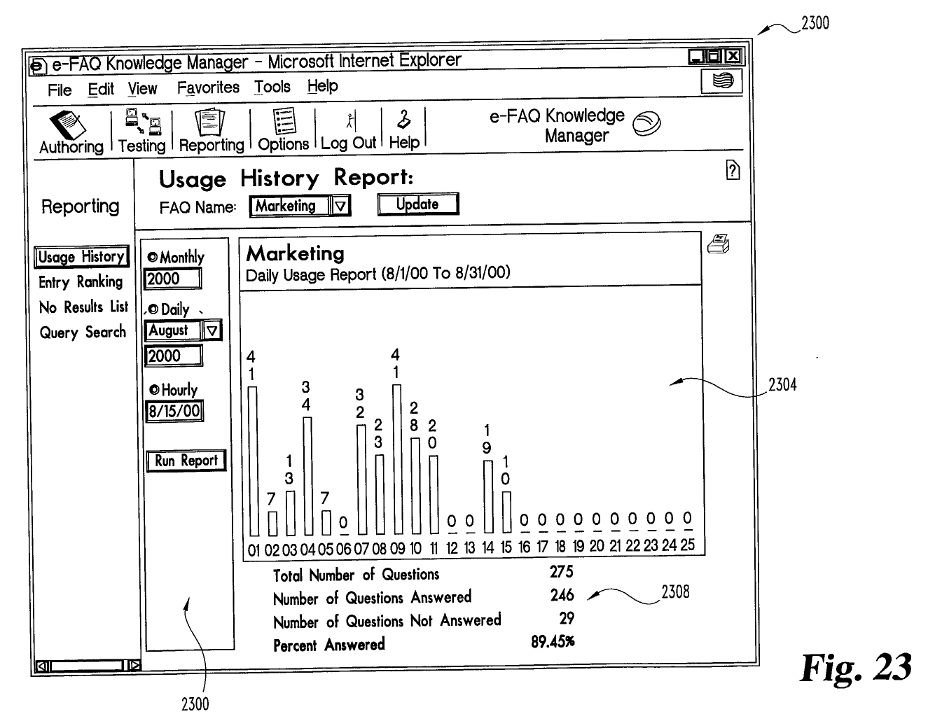

A graphical report screen 2300 is shown in FIG. 23. This report screen 2300 includes a parameters section 2302 for defining the parameters of the graph. The report screen 2300 also includes a graphic section 2304 that graphically displays the results and a numerical statistics section for displaying the statistics of questions asked in numerical form.

It is contemplated that a knowledge base system according to the present invention can omit various features and can include various combinations of the features as described above. Further, a system according to the present invention can include additional features as contemplated by those skilled in the art.

While specific embodiments of the present invention have been shown and described in detail, the breadth and scope of the present invention should not be limited by the above described exemplary embodiments, but should be defined only in accordance with the following claims and their equivalents. All changes and modifications that come within the spirit of the invention are desired to be protected.

What is claimed is:

1. A method, comprising:
operating a knowledge-base system configured to store a database containing answers to questions, the knowledge-base system being operatively coupled to a client computer;
receiving a message from the client computer;
determining the message from the client computer was a reply to a previously generated message from the knowledge-base system; and
forwarding the message from the client computer to a representative in response to said determining.

2. The method of claim 1, wherein the message from the client computer is an email.

3. The method of claim 1, further comprising:
enclosing a message identification number on all communications sent by the knowledge-base system; and
wherein said determining includes searching the message from the client computer for the message identification number.

4. The method of claim 3, wherein said forwarding includes attaching message history information.

5. The method of claim 1, further comprising:
maintaining a communication log of communications sent and received with the knowledge-base system; and
wherein said determining includes ascertaining with the communication log whether a reply detection limit has been exceeded for the client computer.

6. The method of claim 5, wherein the reply detection limit includes a communication interval limit of time intervals between successive communications with the client computer and a number of communications limits based on a number of communications with the client computer.

7. The method of claim 5, wherein the communications maintained in the communication log include email communications, web chatting communications, telephone conversations, and personal conversations.

8. The method of claim 1, wherein the knowledge-base system and the client computer are operatively coupled over a network.

9. The method of claim 1, further comprising:
enclosing a message identification number on all communications sent by the knowledge-base system;
maintaining a communication log of communications sent and received with the knowledge-base system; and
wherein said determining includes searching the message from the client computer for the message identification number and ascertaining with the communication log whether a reply detection limit has been exceeded for the client computer.

10. The method of claim 1, wherein the representative is a human being.

11. The method of claim 1, wherein the representative is an automated system.

12. A method, comprising:
operating a knowledge-base system configured to store a database containing answers to questions and a number of response templates each providing a different response format, the system being operatively coupled to a client computer;
receiving from the client computer an input corresponding to a question;
generating a query result from the database in response to the question from the client computer;
creating a response message based on the question from the client computer, at least one of the response templates, and the query result; and
sending the response message to the client computer.

13. The method of claim 12, wherein said creating includes modifying the response message to indicate that no answers were found when the query result does not contain any answers.

14. The method of claim 12, wherein said creating includes modifying the at least one of the response templates based on the question from the client computer.

15. The method of claim 12, wherein said creating includes selecting the at least one of the templates based upon the query result.

16. The method of claim 12, wherein said generating includes:
calculating a score for each question and answer in the database; and
selecting at least one answer based upon a dynamic threshold resulting from a statistical distribution of all scores.

17. A method, comprising:
operating a system configured with a database including a plurality of question-answer sets;
receiving a query input to the system, the query input including a word;
selecting one or more of the question-answer sets with the system in response to the query input by evaluating presence of the word in one or more answers of the question-answer sets differently than presence of the word in one or more questions of the question-answer sets; and
providing an output from the system based on said selecting.

18. The method of claim 17, wherein said evaluating includes weighting the answers more than the questions.

19. The method of claim 17, wherein said evaluating includes weighting the answers less than the questions.

20. The method of claim 17, further comprising generating one or more word indices, said selecting including referencing the word indices.

21. The method of claim 17, wherein said selecting includes scoring a length of one of the questions in proportion to a length of the query input.

22. The method of claim 17, wherein said selecting includes scoring the question-answer sets to create a distribution of scores and determining the query result based upon variability of the scores.

23. The method of claim 17, further comprising designating one or more words to ignore.

24. The method of claim 17, further comprising alerting a representative when a particular one of the question-answer sets is included in the output.

25. The method of claim 17, further comprising:
designating corresponding weights for the word in the questions and the answers; and
wherein said selecting includes scoring each of the questions and the answers using the corresponding weights.

26. The method of claim 17, further comprising defining aliases for at least one word.

27. The method of claim 17, further comprising designating one of the question-answer sets to always appear in the output for the query input.

28. The method of claim 17, further comprising designating one of the question-answer sets to never appear in the output for the query input.

29. The method of claim 17, further comprising proportionally weighting one of the question-answer sets to reduce likelihood of appearing in the output for the query input.

30. The method of claim 17, further comprising proportionally weighting one of the question-answer sets to increase likelihood of appearing in the output for the query input.

31. The method of claim 17, further adding a question-answer set to the database by email.

32. The method of claim 17, further comprising:
receiving a message from a client computer coupled to the system;
determining the message from the client computer was a reply to a previously generated message from the system; and
forwarding the message from the client computer to a representative in response to said determining.

33. The method of claim 32, further comprising:
creating a response message based on the message from the client computer, at least one of a number of response templates and the selected one or more sets, the system being configured to store the response templates each providing a different response format; and
wherein said providing the output includes sending the response message to the client computer.

34. A method, comprising:
operating a knowledge-base system configured to store a database formatted with a number of question-answer sets, the knowledge-base system being operatively coupled to a client computer;
receiving an input corresponding to a question from the client computer;
scoring the question-answer sets with respect to the question;
determining a threshold limit based upon said scoring; and
selecting the question-answer sets with scores above the threshold limit.

35. The method of claim 34, wherein said determining includes:
calculating variability of scores from said scoring; and
basing the threshold limit on the variability of the scores.

36. The method of claim 34, further comprising:
defining an absolute threshold limit that is universally applicable to all received questions; and
selecting the question-answer sets with scores above the absolute threshold limit.

37. The method of claim 34, further comprising:
creating a reflexive index that includes the question from the client computer and at least the selected question-answer sets from said selecting;
scoring each question from the selected question-answer sets against the reflexive index;
scoring the question from the client against the reflexive index to generate a question score; and
choosing the selected question-answer sets with scores that favorably correlate with the question score.

38. The method of claim 37, wherein the reflexive index further includes all of the question-answer sets.

39. A method, comprising:
operating a knowledge-base system configured to store a database formatted with a number of question-answer sets, the knowledge-base system being operatively coupled to a client computer;
receiving an input corresponding to a question from the client computer;
selecting one or more candidate sets from the question-answer sets based on the question from the client computer;
creating a reflexive index that includes the question from the client computer and at least the candidate sets;
scoring each question from the candidate sets against the reflexive index;
scoring the question from the client against the reflexive index to generate a question score; and
choosing the candidate sets with scores that correlate with the question score.

40. The method of claim 39, wherein the reflexive index further includes all of the question-answer sets.

41. A system comprising:
means for determining a message from a client computer was a reply to a previously generated message from a FAQ database and forwarding the message to a representative in response;
means for evaluating question components and answer components of the FAQ database independently relative to an input query; and
means for providing a response to the FAQ database query in accordance with one or more response templates, the response templates each relating to a different response format.

42. The system of claim 41, further comprising means for selectively hiding or ignoring words included in one or more question-answer entries of the FAQ database.

43. The system of claim 41, further comprising means for providing an alias designation.

44. A system for processing a question from a client computer, comprising:
a database formatted with a number of question-answer sets, said sets each including a question field and a corresponding answer field, each of said question and answer fields being configured to contain one or more words, said database further including a question index that associates each of said words in said question fields with each of said question-answer sets and an answer index that associates said words in said answer fields with each of said question-answer sets;
a matcher operatively coupled to said database to produce a query result using both said question index and said answer index in response to the question from the client computer; and
a processor operatively coupled to said matcher to send said query result to the client computer.
